(19) United States
(12) Patent Application Publication
(10) Pub. No.: US 2026/0093042 A1
(43) Pub. Date: Apr. 2, 2026

(54) ELECTRONIC DEVICE FOR PERFORMING NON-TERRESTRIAL WIRELESS COMMUNICATION, AND OPERATING METHOD OF ELECTRONIC DEVICE

(71) Applicant: SAMSUNG ELECTRONICS CO., LTD., Suwon-si (KR)

(72) Inventors: Hyeonchang SON, Suwon-si (KR); Kihoon Kang, Suwon-si (KR); Hyungpil Kum, Suwon-si (KR); Donghwan Seo, Suwon-si (KR); Jinbae Lee, Suwon-si (KR); Kyeongmun Jo, Suwon-si (KR)

(73) Assignee: SAMSUNG ELECTRONICS CO., LTD., Suwon-si (KR)

(21) Appl. No.: 19/410,681

(22) Filed: Dec. 5, 2025

Related U.S. Application Data
(63) Continuation of application No. PCT/KR2024/095817, filed on May 17, 2024.

(30) Foreign Application Priority Data
Jun. 7, 2023 (KR) 10-2023-0072816
Jul. 10, 2023 (KR) 10-2023-0089332

(51) Int. Cl. G01S 19/20; G01S 19/17; G01S 19/33

(52) U.S. Cl. CPC G01S 19/20; G01S 19/17; G01S 19/33

(57) ABSTRACT

An electronic device is provided. The electronic device includes a global navigation satellite system (GNSS) receiver, a communication circuit, a display, memory, and at least one processor connected to the GNSS receiver, the communication circuit, the display, and the memory. The at least one processor is configured to control an operation of the electronic device in a designated operating mode based on an occurrence of an emergency, and receive a GNSS signal through the GNSS receiver; determine, based on a strength of the GNSS signal, whether to perform satellite communication through the communication circuit; and provide, through the display, guide information for performing the satellite communication based on non-performance determination of the satellite communication.

### CROSS REFERENCE TO RELATED APPLICATION(S)

This application is a bypass continuation application of International Patent Application No. PCT/KR2024/095817, filed on May 17, 2024, which claims priority to Korean Patent Application No. 10-2023-0072816, filed on Jun. 7, 2023 and Korean Patent Application No. 10-2023-0089332, filed on Jul. 10, 2023, the disclosures of which are incorporated herein by reference in their entireties.

### BACKGROUND

### 1. Field

Embodiments disclosed in the present disclosure relate to an electronic device for performing non-terrestrial wireless communication and an operating method of the electronic device.

### 2. Description of Related Art

Portable electronic devices, such as smartphones or tablets, may perform communication through various communication systems, such as cellular communication or short-range wireless communication, and may transmit and receive various pieces of information through various media according to the user needs.

However, in emergency situations or regions with unstable communication infrastructure non-terrestrial wireless communication (e.g., satellite communication) services may be used. For example, the electronic device may transmit an SOS signal or a help request message for emergency through the non-terrestrial wireless communication (e.g., satellite communication), and the transmitted message may be delivered to a rescue team or relevant authorities located on the ground.

However, the non-terrestrial wireless communication services may consume a large amount of power, and due to the nature of radio waves, a communication success rate may significantly decrease depending on the location or environmental conditions of the electronic device.

The above-described information may be provided as related art for the purpose of assisting in understanding the present disclosure. No claim or determination is made as to whether any of the above-described contents is applicable as prior art related to the present disclosure.

### SUMMARY

According to an aspect of one or more embodiments of the present disclosure, an electronic device may include a global navigation satellite system (GNSS) receiver, a communication circuit, a display, memory, at least one processor connected to the GNSS receiver, the communication circuit, the display, and the memory. The the at least one processor may be configured to control an operation of the electronic device in a designated operating mode based on an occurrence of an emergency, and receive a GNSS signal through the GNSS receiver; determine, based on a strength of the GNSS signal, whether to perform satellite communication through the communication circuit; and provide, through the display, guide information for performing the satellite communication based on non-performance determination of the satellite communication.

The at least one processor may be further configured to provide, based on the strength of the GNSS signal, the guide information comprising at least one of a posture or a direction of the electronic device for performing the satellite communication.

The electronic device may further include a geomagnetic sensor. The at least one processor may be further configured to confirm the posture of the electronic device through the geomagnetic sensor; and provide the guide information for guiding a change in the posture of the electronic device.

The electronic device may further include a gyro sensor. The at least one processor may be further configured to confirm the direction of the electronic device through the gyro sensor; and provide the guide information for guiding a change in the direction of the electronic device.

The at least one processor may be further configured to compare the direction of the electronic device confirmed through the gyro sensor with satellite communication signal strength confirmed through the communication circuit; and based on the comparison, provide the guide information for guiding the change in the direction of the electronic device The at least one processor may be further configured to provide the guide information for rotating the electronic device at a designated speed in order to compare the satellite communication signal strength with the direction of the electronic device.

The electronic device may be foldable device with the display being foldable. The at least one processor may be further configured to provide the guide information for folding the display within a designated angle range and for positioning the electronic device on a ground.

The at least one processor may be further configured to acquire environmental information comprising at least one of location information, obstacle information, altitude information, or weather information; and generate the guide information based on the environmental information.

The at least one processor may be configured to acquire the weather information from the memory; compare the weather information with a current location and time information acquired through the GNSS signal; and generate the guide information based on the comparison.

The at least one processor may be further configured to block, depending on the designated operating mode, a wireless network communication function through the communication circuit; adjust a brightness of the display; terminate an application being executed by the at least one processor; block one or more core operations; and change a clock frequency.

According to another aspect of one or more embodiments of the present disclosure, the method may include controlling an operation of the electronic device in a designated operating mode based on an occurrence of an emergency; receiving a global navigation satellite system (GNSS) signal through a GNSS receiver of the electronic device; determining, based on a strength of the GNSS signal, whether to perform satellite communication through a communication circuit of the electronic device; and providing, through the display of the electronic device, guide information for performing the satellite communication based on non-performance determination of the satellite communication.

The method of providing of the guide information may include providing the guide information including at least one of a posture or a direction of the electronic device for performing the satellite communication based on the strength of the GNSS signal.

The method of providing of the guide information may include providing the posture of the electronic device is confirmed through a geomagnetic sensor of the electronic device, the guide information for guiding a change in the posture of the electronic device; and providing the guide information for confirming the direction of the electronic device through a gyro sensor of the electronic device and guiding a change in the direction of the electronic device.

The method of providing of the guide information may include providing of the guide information comprises comparing the direction of the electronic device confirmed through the gyro sensor with satellite communication signal strength confirmed through the communication circuit to provide the guide information for guiding the change in the direction of the electronic device.

According to another aspect of one or more embodiments of the present disclosure, aA non-transitory computer-readable storage medium having stored thereon instructions that, when executed by a processor, cause the processor to control an operation of an electronic device in a designated operating mode based on an occurrence of an emergency, and receiving a GNSS signal through a global navigation satellite system (GNSS) receiver of an electronic device; determine, based on a strength of the GNSS signal, whether to perform satellite communication through a communication circuit of the electronic device; and provide, through the display of the electronic device, guide information for performing the satellite communication based on non-performance determination of the satellite communication The technical problems, solutions, and/or effects to be achieved in the document are not limited to the technical problems, solutions, and/or effects mentioned above, and other technical problems, solutions, and/or effects not mentioned may be clearly understood by those skilled in the art to which the present disclosure pertains from the description below.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an electronic device within a network environment, according to one embodiment;

FIG. 2 is a block diagram of the electronic device according to one embodiment;

FIG. 3 is a diagram illustrating the electronic device according to one embodiment and a long-distance communication network environment;

FIG. 4 is a diagram for describing characteristics of a non-terrestrial communication antenna of the electronic device according to one embodiment;

FIG. 5 is a flowchart for describing an example of a non-terrestrial communication service execution operation of the electronic device according to one embodiment;

FIG. 6 is a flowchart for describing an example of the non-terrestrial communication service execution operation of the electronic device according to one embodiment;

FIG. 7 is a diagram for describing signal strength according to the surrounding environment of the electronic device according to one embodiment;

FIG. 8 is a flowchart for describing an example of a non-terrestrial communication service guidance operation of the electronic device according to one embodiment;

FIG. 9 is a diagram for describing the non-terrestrial communication service guidance operation of the electronic device according to one embodiment;

FIG. 10 is a diagram for describing the non-terrestrial communication service guidance operation of the electronic device according to one embodiment;

FIG. 11 is a flowchart for describing an example of the non-terrestrial communication service execution operation of the electronic device according to one embodiment;

FIG. 12 is a diagram for describing an example of a non-terrestrial communication service execution guidance operation of the electronic device according to one embodiment;

FIG. 13 is a flowchart for describing an example of the non-terrestrial communication service execution guidance operation of the electronic device according to one embodiment;

FIG. 14 is a diagram for describing the non-terrestrial communication service execution operation of the electronic device according to one embodiment;

FIG. 15 is a diagram for describing signal strength according to a direction of a plurality of satellite signals according to one embodiment;

FIG. 16 is a diagram for describing an example of the non-terrestrial communication service execution guidance operation of the electronic device according to one embodiment;

FIG. 17 is a flowchart for describing an example of the non-terrestrial communication service execution guidance operation of the electronic device according to one embodiment;

FIG. 18 is a diagram for describing non-terrestrial signal strength according to a state of the electronic device according to one embodiment;

FIG. 19 is a flowchart for describing an example of the non-terrestrial communication service execution guidance operation of the electronic device according to one embodiment; and

FIG. 20 is a diagram for describing an example of the non-terrestrial communication service execution guidance operation of the electronic device according to one embodiment.

### DETAILED DESCRIPTION

Hereinafter, embodiments of the disclosure will be described in detail with reference to the drawings so that those skilled in the art to which the disclosure pertains can easily implement the disclosure. However, the disclosure may be implemented in various different forms and is not limited to embodiments set forth herein. With regard to the description of the drawings, the same or like reference signs may be used to designate the same or like elements. Also, in the drawings and the relevant descriptions, description of well-known functions and configurations may be omitted for the sake of clarity and brevity.

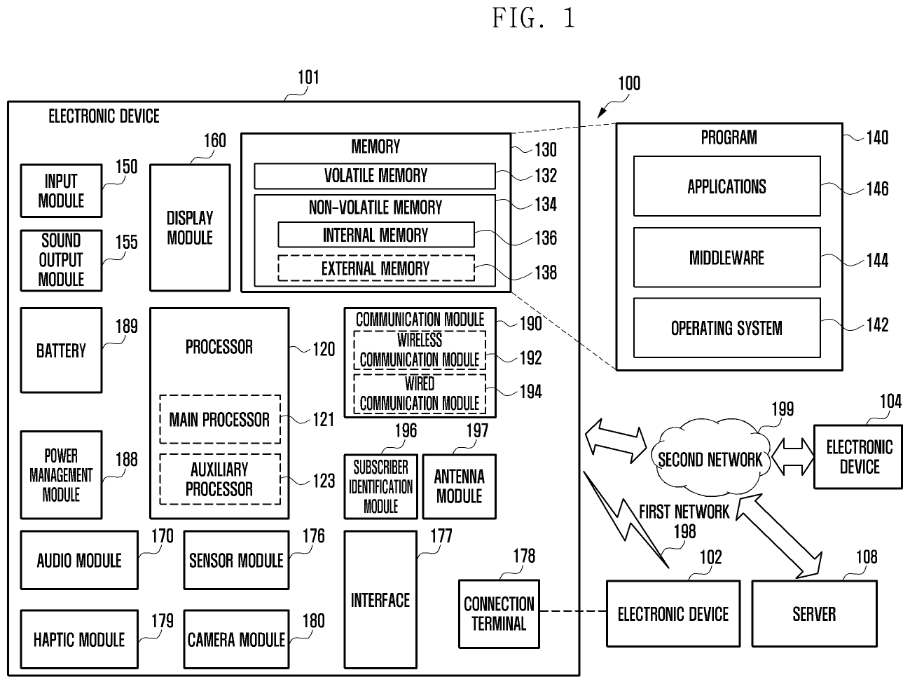

FIG. 1 is a block diagram illustrating an electronic device in a network environment according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

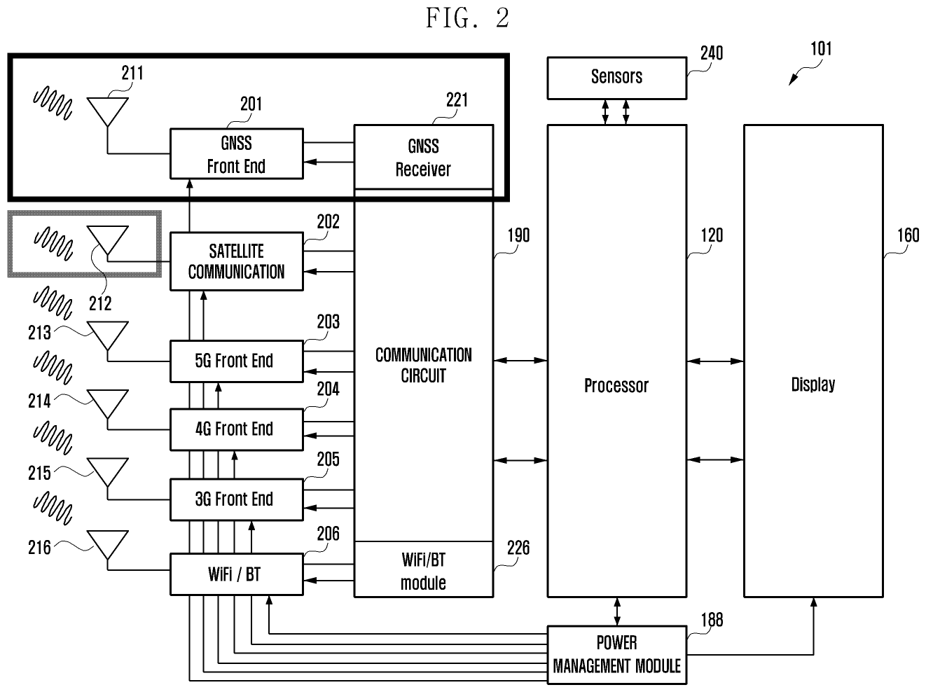

FIG. 2 is a block diagram of an electronic device (e.g., the electronic device 101 of FIG. 1) according to one embodiment. The electronic device 101 of FIG. 2 may include various electronic devices, such as smartphones or tablets. For example, the electronic device 101 may have various shapes, such as a bar shape, a foldable structure (e.g., a foldable phone), and an expandable structure (e.g., a rollable phone), and is not limited to the examples described below.

Referring to FIG. 2, the processor (e.g., the processor 120 of FIG. 1) may include one or more processors and may operate as a central processing unit (CPU) that is connected to (e.g., physically connected, logically connected, operatively connected) each component of the electronic device 101 and performs computation or data processing related to control and/or communication of each component. For example, the processor 120 may execute various types of software stored in a memory (e.g., the memory 130 of FIG. 1), process various data to transmit and receive through a communication circuit (e.g., the communication module 190 of FIG. 1), and manage a user interface provided through a display (e.g., the display module 160 of FIG. 1). The characteristics will be described in detail in which the processor 120 determines communication situations, controls the operation of each component of the electronic device 101, and provides emergency communication services by controlling cellular communication and non-terrestrial communication according to the communication environment. However, the computational and data processing functions that may be implemented on the electronic device 101 are not limited to the description below. The operations of the processor 120 may be performed by loading instructions stored in the memory 130.

According to one embodiment, the communication circuit (e.g., the communication module 190 of FIG. 1) may include a communication processor that supports wired or wireless communication and may support various wireless communication technologies, including global system for mobile communications (GSM), code-division multiple access (CDMA), long-term evolution (LTE), 5G, global navigation satellite system (GNSS) (e.g., satellite-based system that provides autonomous geospatial positioning with global coverage), or non-terrestrial communication, thereby transmitting and/or receiving various data and voice calls.

According to one embodiment, the communication circuit 190 may include a GNSS receiver 221 and/or a short-range wireless communication module 226. The GNSS receiver 221 and/or the short-range wireless communication module 226 are described herein as being included in the communication circuit 190, but the embodiments are not limited thereto. The GNSS receiver 221 and/or the short-range wireless communication module 226 may also be implemented as separate chips.

According to one embodiment, the communication circuit 190 may include a non-terrestrial communication circuit (not explicitly illustrated) for performing non-terrestrial communication. The non-terrestrial communication circuit is described herein as being integrated into the communication circuit 190, but may also be implemented as a separate chip from the communication circuit 190.

In describing the non-terrestrial wireless communication, the terms “satellite” and “satellite communication” may be used as examples. However, this is for convenience of description, and the embodiments are not limited thereto. According to one embodiment, the GNSS receiver 221 may support various satellite navigation systems, including the global positioning system (GPS), the global navigation satellite system (GLONASS), Beidou, Galileo, and operate as a receiver that receives GNSS signals.

According to one embodiment, the short-range wireless communication module 226 may support, for example, wireless LAN (e.g., WiFi) and Bluetooth (BT) communications, and enable the electronic device 101 to be connected to the Internet and/or other Bluetooth devices.

According to one embodiment, a GNSS front end 201 may be connected to a GNSS antenna 211 and the GNSS receiver 221, and may filter and/or low-noise amplify a GNSS signal received through the GNSS antenna 211 and transmit the GNSS signal to the GNSS receiver 221.

According to one embodiment, RF front ends (e.g., a 5G front end 203, a 4G front end 204, and a 3G front end 205) may be each connected to an antenna (e.g., a 5G antenna 213, a 4G antenna 214, and a 3G antenna 215, the antenna module 197 of FIG. 1) and the communication circuit 190, respectively, and may filter or amplify a transmitted and/or received signal. For this purpose, the RF front ends 203, 204, 205, and 206 may include a low-noise amplifier (LNA), a filter (e.g., a bandpass filter and/or a duplexer), and/or a power amplifier (PA). The RF front ends (e.g., 5G front end 203, 4G front end 204, 3G front end 205 and/or BT/WiFi front end 206) that process signals transmitted and/or received through legacy cellular networks such as 3G and/or 4G, and/or 5G or next-generation communication networks, or short-range wireless communication networks such as BT or WiFi, may be implemented as separate components or implemented to share some parts.

According to one embodiment, the antennas 213, 214, 215, and 216 may each include a plurality of antennas (e.g., array antennas) that include antennas for one or more designated frequency bands (e.g., legacy band of approximately 800 MHz to 6000 MHz, and/or band of approximately 3 GHz to 300 GHz).

According to one embodiment, a satellite communication front end 202 may be connected to the satellite communication antenna 212 and the communication circuit 190, and may filter or amplify satellite communication signals transmitted and/or received through the satellite communication antenna 212. For this purpose, the satellite communication front end 202 may include a low-noise amplifier (LNA), a filter (e.g., a band-pass filter and/or a duplexer), and/or a power amplifier (PA). Although the satellite communication antenna 212 is described herein as a separate antenna from the antennas 213, 214, and 215, the satellite communication antenna 212 may also be implemented, for example, using the approximately 1.6 GHz high-frequency band antenna of the antenna 213. The satellite communication antenna 212 may include a directional radiation pattern for power efficiency.

According to one embodiment, sensors 240 (e.g., the sensor module 176 of FIG. 1) may include an acceleration sensor for detecting movement, a gyro sensor for measuring a rotational speed, a geomagnetic sensor for measuring a direction, and a barometric pressure sensor that may be used for measuring atmospheric pressure and calculating altitude.

According to one embodiment, the display (e.g., the display module 160 of FIG. 1) may visually display various pieces of information and may include a touch sensor for detecting user input.

According to one embodiment, a power management module (e.g., the power management module 188 of FIG. 1) may manage power supplied to each component of the electronic device 101. The power management module 188 may perform functions such as battery life extension, charge and discharge management, and power consumption management, thereby controlling the power consumption of the electronic device 101 and extending the battery life.

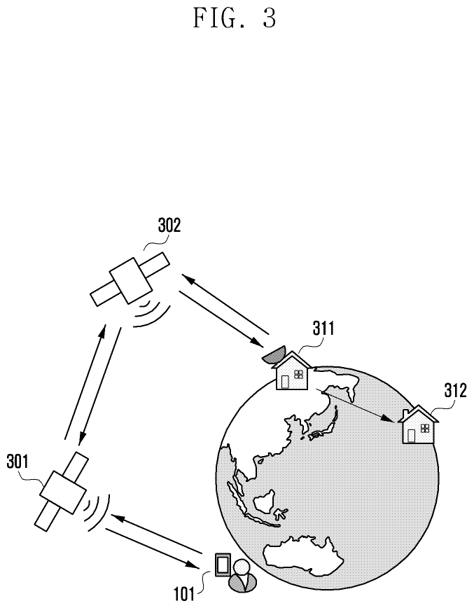

FIG. 3 is a diagram illustrating the electronic device (e.g., the electronic device 101 of FIG. 1 or 2) and a long-distance communication network environment according to one embodiment.

General wireless communication networks (e.g., a radio access network (RAN)) may transmit and/or receive signals to and from the electronic device 101 through a base station (cell tower) installed on the ground. The coverage of the general cell tower may be approximately 1.6 to 5 km. When the electronic device 101 is out of the coverage, communication is impossible, so communication services may only be provided in specific regions, such as cities where the cell tower is installed. The communication speed provided through the general wireless communication networks may be up to approximately 114 kbps for 2G, up to approximately 14.4 Mbps for 3G, up to approximately 1 Gbps for 4G, and up to approximately 20 Gbps for 5G.

For the non-terrestrial communication, non-terrestrial communication devices, such as low earth orbit satellites operating at an altitude of approximately 300 to 2,000 km, may be used. For example, multiple satellites may be distributed in Earth's orbit and thus one or more satellites are visible even at various times and locations, so the coverage may be very extensive, spanning the entire globe. However, the maximum data rate for communications between mobile devices and satellites is approximately 2.4 kbps, enabling the transmission and/or reception of data such as short messages with a small amount of data or location information.

According to one embodiment, the non-terrestrial communication system may include one or more non-terrestrial wireless communication devices 301 and/or 302, a terrestrial wireless communication device (e.g., ground station) 311, and an electronic device (e.g., the electronic device 101 of FIG. 1 or 2).

The electronic device 101 according to one embodiment may transmit and/or receive data through a terrestrial network and/or a non-terrestrial network.

The terrestrial network may refer to a network capable of providing data communication through the terrestrial wireless communication device 311. For example, the terrestrial wireless communication device 311 may include a cell tower located on the ground (e.g., fixed on the ground). The terrestrial wireless communication device 311 may support at least one of various communication schemes supported by the electronic device 101. For example, the terrestrial wireless communication device 311 may include an eNodeB or a gNodeB, but there is no limitation on the type thereof.

The non-terrestrial network may refer to a network capable of providing data communication through the non-terrestrial wireless communication devices 301 and/or 302. For example, the non-terrestrial wireless communication devices 301 and/or 302 may include at least one of various communication devices, such as cell towers and repeaters, that are not located on the ground. For example, the non-terrestrial wireless communication devices 301 and/or 302 may include satellites and/or unmanned aerial vehicles, but there is no limitation on the type thereof. For example, the satellite may include a low-earth orbit (LEO) satellite, a medium-earth orbit (MEO) satellite, a geostationary earth orbit (GEO) satellite, and/or a high elliptical orbit (HEO) satellite. Hereinafter, in describing the non-terrestrial network, the terms satellite, satellite communication, and satellite network may be used as examples. However, this is for convenience of description, and the embodiments are not limited thereto.

The non-terrestrial wireless communication devices 301 and/or 302 may support at least one of various wireless communication schemes. For example, the non-terrestrial wireless communication devices 301 and/or 302 may support a non-terrestrial network (NR NTN) defined by a 3rd generation partnership project (3GPP). Alternatively, the non-terrestrial wireless communication devices 301 and/or 302 may support at least one of the communication schemes based on various communication standards, such as LTE, global system for mobile communications (GSM), and code-division multiple access (CDMA), but there is no limitation on the type thereof.

The terrestrial network and the non-terrestrial network may be independent networks. Alternatively, the terrestrial network and the non-terrestrial network may be included in at least one network (e.g., a network provided by the same operator) associated with each other.

The electronic device 101 may perform wireless communication through the non-terrestrial network when the communication with the terrestrial network is unavailable or is not smooth. Alternatively, in some cases, the electronic device 101 may also perform the wireless communication through the non-terrestrial network regardless of the communication state with the terrestrial network.

According to one embodiment, the electronic device 101 may communicate with the satellite 301 through a service link. The service link between the electronic device 101 and the non-terrestrial wireless communication device 301 may perform low-speed communication using a low-frequency frequency (e.g., approximately 1616 to 1626 MHz) for communication between a non-terrestrial wireless communication device in space and the terrestrial electronic device, and may require approximately several minutes to transmit data such as text messages (e.g., emergency communication messages).

According to one embodiment, the non-terrestrial wireless communication device 301 and the non-terrestrial wireless communication device 302 may communicate at a high transmission speed through an inter-satellite link using optical or high-frequency bands in space. The non-terrestrial wireless communication device 301, which receives data from the electronic device 101, may transmit the received data to the non-terrestrial wireless communication device 302 closest to the terrestrial wireless communication device 311.

According to one embodiment, the non-terrestrial wireless communication device 302 may communicate with the terrestrial wireless communication device 311 through a feeder link that may use a wider frequency bandwidth at a higher frequency than the service link. The non-terrestrial wireless communication device 302 may transmit data from the electronic device 101 to the terrestrial wireless communication device 311 through the feeder link, and the terrestrial wireless communication device 311 may transmit an emergency communication message to an emergency center 312 through the wireless communication network.

According to one embodiment, in a situation where a user requires communication during various outdoor activities (e.g., jogging, marathon, cycling, golf, hiking, military activities) in regions where wireless communication networks are not provided (e.g., remote regions) and wireless communication services are unavailable (e.g., in the occurrence of an accident or distress), the electronic device 101 may activate an emergency communication (e.g., SOS emergency) service function through satellite communication.

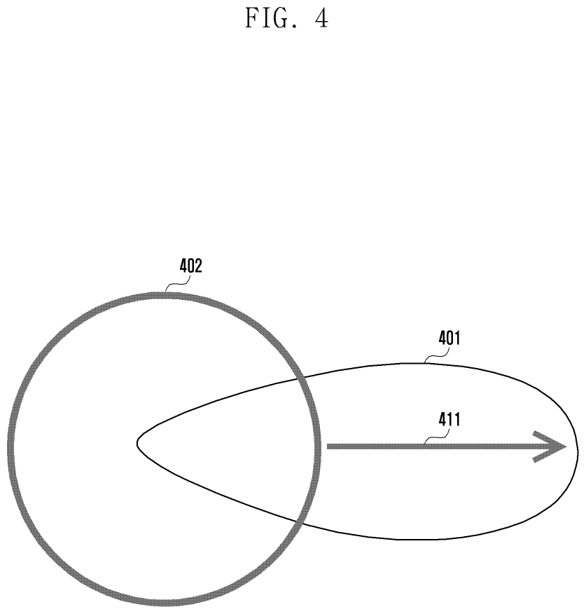

FIG. 4 is a diagram for describing the characteristics of a satellite communication antenna of the electronic device (e.g., the electronic device 101 of FIG. 1 or 2) according to one embodiment.

When the electronic device 101 performs the satellite communication, more power may be consumed compared to an average power during the general wireless communication, which may be problematic in regions where the supply of power is limited or power may be unavailable.

In a wireless communication network, since the cell tower is relatively close to the electronic device 101 for cellular communication, the power required for transmitting and receiving signals in the electronic device 101 may be maintained at a level of up to approximately 23 dBm (200 mW).

In the case of the satellite communication, since the distance between the satellite and the electronic device 101 may be approximately 300 km or more, the strength of power required for transmitting and receiving signals may need to be at least, for example, approximately 35 to 37 dBm (3.2 to 5 W). As a result, the satellite communication may require approximately, for example, 16 to 25 times more power than the cellular communication. The satellite communication may be subject to limitations depending on the environment in which the satellite communication is used. For example, obstacles to communication between the electronic device 101 and the satellite may be created in environments other than open sky, such as forested areas, deep canyons, or under weather conditions (e.g., clouds or rain). In this case, more power may be consumed.

The general wireless communication antennas are generally isotropic, as shown in a graph 402. In order to communicate with a satellite at a specific location (e.g., in the sky above) using an antenna having isotropic characteristics, a very large amount of power may be required.

In the case of mobile devices such as the electronic devices 101, power is limited, so it may be necessary to focus power in a specific direction when performing a power-consuming operation such as the satellite communication. Therefore, to perform the satellite communication, the satellite communication antennas may be implemented to have directional characteristics, as shown in the graph 401. For this purpose, the satellite communication antennas may be implemented to have a high gain 411 to focus radio waves in a specific direction. In the case of the directional antenna, aligning the antenna toward the satellite may be advantageous for power management and/or communication strength.

Hereinafter, an operating method of an electronic device (e.g., the electronic device 101 of FIG. 1 or 2) according to various embodiments will be described in detail. Operations performed by the electronic device 101 according to various embodiments may be executed by a processor (e.g., the processor 120 of FIG. 1 or 2) including various processing circuitry and/or executable program elements of the electronic device 101. According to one embodiment, the operations performed by the electronic device 101 may be stored in a memory (e.g., the memory 130 of FIG. 1) and, upon execution, executed by instructions that cause the processor 120 to operate.

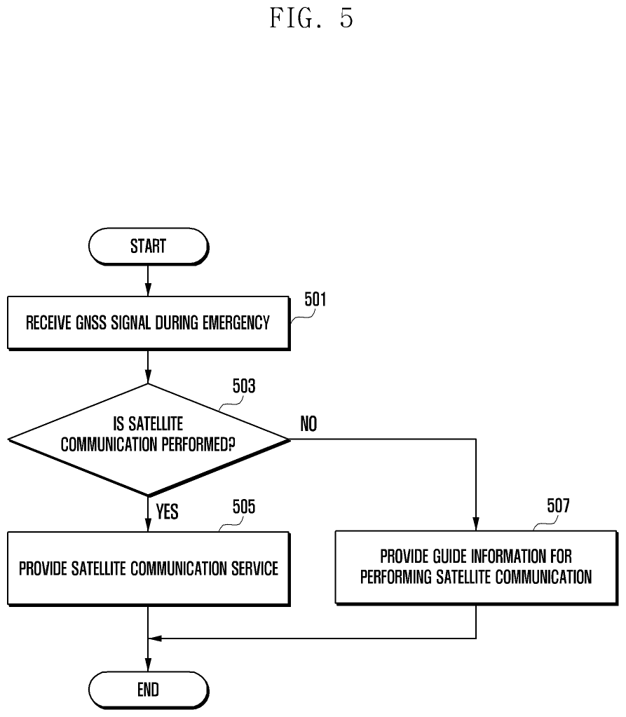

FIG. 5 is a flowchart for describing an example of a satellite communication service execution operation of the electronic device according to one embodiment.

According to one embodiment, the electronic device 101 may enter a survival mode (e.g., a low-power mode, energy saving mode, battery saving mode, sleep mode, eco mode), and/or perform guidance operations for performing satellite communication.

In the following embodiments, each operation may be performed sequentially, but is not necessarily performed sequentially. For example, the order of each operation may be changed, and at least two operations may also be performed in parallel.

According to one embodiment, in operation 501, the processor 120 of the electronic device 101 may control the operation of the electronic device in a designated operating mode based on the occurrence of an emergency and receive a global navigation satellite system (GNSS) signal. The processor 120 may receive a GNSS signal through a GNSS receiver (e.g., the GNSS receiver 221 of FIG. 2). The GNSS signal may include information for determining a current location of the electronic device 101.

According to one embodiment, the processor 120 of the electronic device 101 may determine that the emergency has occurred based on an external input. For example, the processor 120 may determine that the emergency has occurred as the emergency communication function of the electronic device 101 is activated. For example, the processor 120 may confirm the operation of the communication circuit (e.g., the communication module 190 of FIG. 1) of the electronic device 101 as the emergency communication service function is activated, and may confirm whether the communication is available through the general wireless communication network, including cellular communication, WiFi, and Bluetooth communication.

According to one embodiment, the emergency may include various situations in which the emergency communication is performed using the satellite communication services. For example, the emergency may include situations in which rescue is required or it is difficult to access to a wireless network (e.g., cellular communication, WiFi communication) in remote regions (e.g., deserts, mountainous terrain, islands, oceans) beyond the coverage of the cell tower.

The emergency communication services through the satellite communication may be performed at a relatively slow communication speed, and thus, text messages including relatively simple contents (e.g., location, situation description, age, gender, and health condition of a user) may be delivered and a large amount of power may be consumed. In the case of wireless communication networks, such as cellular communication, since the cell tower is relatively close to the electronic device 101, the power consumption of the electronic device 101 may be maintained at a level of up to, for example, approximately 23 dBm (200 mW). However, in the case of satellite communication, since the electronic device 101 is far from the satellite, the electronic device 101 may consume power of up to, for example, approximately 35 to 37 dBm (3.2 to 5 W), which may require, for example, approximately 16 to 25 times more power than the cellular communication.

According to one embodiment, upon the occurrence of the emergency, the processor 120 may execute the survival mode in which at least some of the other functions consuming the battery power of the electronic device 101 are blocked to increase the duration of the satellite communication. For example, compared to a general power-saving mode, in the survival mode, the processor 120 may block all communication functions except the satellite communication for providing the emergency communication services. For example, the processor 120 may terminate all other apps except those necessary for performing the emergency communication services. For example, the processor 120 may lower the brightness of the display to a certain level or below. For example, the processor 120 may operate sensors (e.g., a geomagnetic sensor, an acceleration sensor, a gyro sensor, and a barometric pressure sensor) designated as necessary for survival. Accordingly, the processor 120 may reduce battery consumption by terminating other functions of the electronic device 101 as much as possible, except for the use of sensors designated as necessary for survival and GNSS positioning.

According to one embodiment, in operation 503, the processor 120 may determine whether to perform the satellite communication based on the strength of the GNSS signal. To determine the strength of the GNSS signal, the processor 120 may utilize, for example, a carrier-to-noise density ratio (C/N0) level of the GNSS signal.

According to one embodiment, the GNSS signal may be transmitted from a satellite that provides positioning services based on satellite navigation systems such as GPS, GLONASS, Beidou, Galileo, etc. The strength of the GNSS signal may reflect the satellite communication environment.

According to one embodiment, the processor 120 may determine to perform the satellite communication when the strength of the GNSS signal is greater than or equal to the designated level, and determine not to perform satellite communication when the strength of the GNSS signal is less than the designated level.

According to one embodiment, in operation 505, the processor 120 may provide the emergency communication services to the electronic device 101 through satellite communication based on the performance determination of the satellite communication.

According to one embodiment, the processor 120 may generate the emergency communication message based on the input or collected information, and may generate a satellite communication signal through a communication circuit (e.g., the communication module 190 of FIG. 1) and a satellite communication front end (e.g., the satellite communication front end 202 of FIG. 2) based on the emergency communication message, and transmit the satellite communication signal through an antenna (e.g., the antenna 212 of FIG. 2). The processor 120 may acquire various pieces of information, including the location, current situation, personal information (e.g., age, gender), and current health condition of the user through the memory (e.g., the memory 130 of FIG. 1), the GNSS receiver 221, or the sensors (e.g., the sensor module 176 of FIG. 1 or the sensors 240 of FIG. 2) of the electronic device 101.

According to one embodiment, in operation 507, the processor 120 may provide guide information for performing the satellite communication based on the non-performance determination of the satellite communication.

According to one embodiment, the processor 120 may collect environmental information on the current location and time based on the non-performance determination of the satellite communication. For example, in addition to the strength of the GNSS signal information, the processor 120 may collect various surrounding environmental information, including map information on the current location confirmed through the GNSS signal, status information of the electronic device 101 through the sensors, barometric pressure information collected through the memory 130 or sensors, and weather information.

According to one embodiment, the processor 120 may generate the guide information for performing the satellite communication based on the GNSS signal information, the status information of the electronic device 101, and the collected environmental information. For example, when it is determined that the antenna direction of the electronic device 101 is not toward the satellite based on the status information of the electronic device 101, the guide information on the satellite direction may be generated. For example, when the current location is inappropriate for performing satellite communication, for example, when the current location is at a lower altitude compared to the surroundings or when obstacles (e.g., forests or mountains) exist around the current location, guide information may be generated to move the electronic device 101 to other locations so as to perform the satellite communication. For example, when the current weather conditions, such as cloudy skies or rain, make the electronic device 101 inappropriate to perform the satellite communication, the guide information for a timing at which the satellite communication may be performed may be generated based on the weather information.

According to one embodiment, the processor 120 may provide antenna usage guide information for performing the satellite communication. The satellite communication may be more sensitive to the impact of the surrounding environment (e.g., obstacles, weather) than the general wireless network communication. Various surrounding environmental conditions may affect a line-of-sight (LOS) between the satellite and the electronic device 101. The processor 120 may provide guidance on the use of the satellite communication antennas to perform the smooth satellite communication. For example, the processor 120 may use the GNSS signal (e.g., signal strength) to determine whether the satellite communication is appropriate at the current location, and when it is determined that the satellite communication is inappropriate at the current location, may guide the electronic device 101 to move to other locations. For example, the processor 120 may use various sensors, such as an acceleration sensor, to confirm the posture and/or direction of the electronic device 101 or provide guidance (e.g., angle or azimuth relative to the ground) on the state of the electronic device 101 to align the line-of-sight (LOS) with the satellite. For example, when the electronic device 101 is implemented as a foldable device, the processor 120 may change, for example, the state of the electronic device 101 to a flex mode to guide the antenna direction to be fixed in a specific direction.

According to one embodiment, the processor 120 may use GNSS signals to provide guidance on a location and/or time suitable for satellite communication to align the line-of-sight (LOS) between the satellite and the electronic device 101. To this end, the processor 120 may collect various pieces of environmental information through sensors in addition to map information and/or weather information pre-stored in the electronic device 101.

According to one embodiment, the processor 120 may infer the satellite signal strength from the current location through the global navigation satellite system (GNSS). The GNSS is available worldwide without a wireless network. For example, satellite constellations such as GPS (United States), GLONASS (Russia), BeiDou (China), and Galileo (European Union) may be provided. Each satellite constellation may operate with, for example, at least 24 satellites and is designed to receive signals from at least four satellites anywhere in the world at any time zone.

The GNSS signal may include GPS (1575.42 MHz), GLONASS (1602 MHz), Beidou (1561.098 MHz), and Galileo (1575.42 MHz) for an upper L band L1, and GPS (1176.45 MHz), Galileo (1176.45 MHz), GLONASS, and Beidou (1207.14 MHz) for a lower L band L5. The GNSS satellite may transmit signals for positioning, and a ground receiver (e.g., the electronic device 101) may measure the strength of the received GNSS signal, for example, by the carrier-to-noise density ratio (C/N0) level.

According to one embodiment, the processor 120 may receive GNSS position signals transmitted from the GNSS satellites and calculate the position of the electronic device 101. Like the general communication satellite, the GNSS satellite signal may be affected by the surrounding environmental conditions and weather (e.g., cloud, rain). Therefore, by utilizing the strength (e.g., C/N0 level) of the GNSS signal, one or more environments where satellite communication operates smoothly may be explored.

The GNSS antenna (e.g., the GNSS antenna 211 of FIG. 2) mounted on the electronic device 101 may have isotropic characteristics, and thus receive signals from all satellites regardless of their location in the sky. Therefore, the GNSS antenna may receive the signal from the GNSS satellite located in various directions. However, the antenna (e.g., the antenna 212 of FIG. 2) used in the satellite communication has directional characteristics and may be inappropriate for identifying the overall satellite communication environment because the antenna only receives a signal in a specific direction.

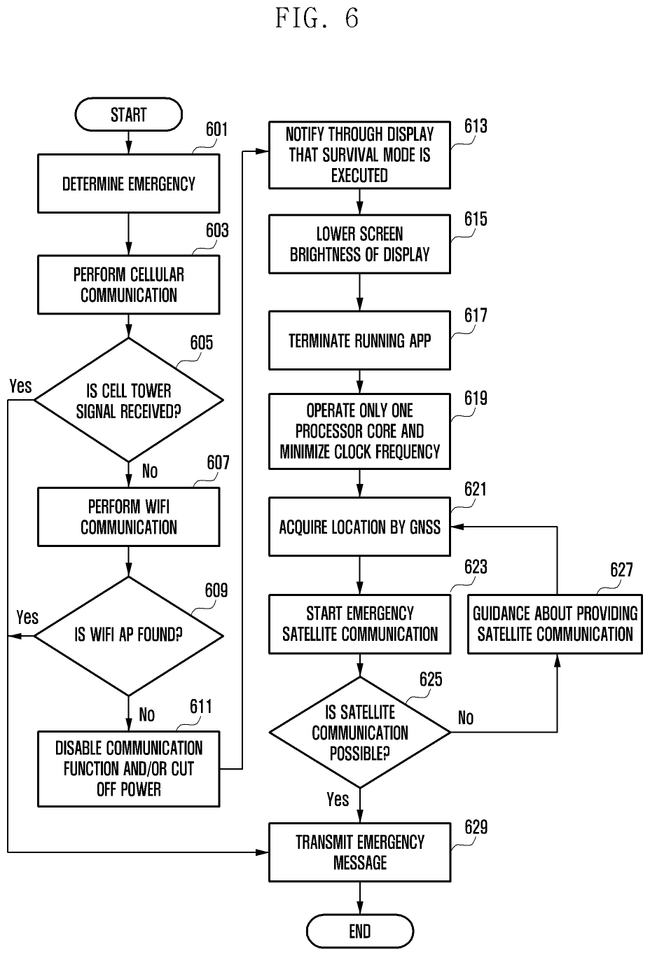

FIG. 6 is a flowchart for describing an example of a satellite communication service operation performed by the electronic device (e.g., the electronic device 101 of FIG. 1 or 2) according to one embodiment.

In the following embodiments, each operation may be performed sequentially. Alternatively, the order of each operation may be changed, and at least two operations may also be performed in parallel. In some examples, one or more operations may be skipped or repeated one or more times.

According to one embodiment, in operation 601, the processor (e.g., the processor 120 of FIG. 1 or 2) of the electronic device 101 may determine that an emergency has occurred. For example, the processor 120 may determine that the emergency has occurred as the emergency communication function of the electronic device 101 is activated.

According to one embodiment, the processor 120 may, in operation 603, activate the communication circuit (e.g., the communication module 190 of FIG. 1) of the electronic device 101 to perform the cellular communication as the emergency communication function is activated, and may, in operation 605, confirm whether the cell tower signal is received.

According to one embodiment, when the cell tower signal is not received, the processor 120 may perform short-range wireless communication, including WiFi or Bluetooth communication, in operation 607. When the cell tower signal is received in operation 605, the processor 120 may proceed to operation 629 to transmit the emergency message through the cell tower.

According to one embodiment, when a WiFi access point (AP) is not found in operation 609, the processor 120 may proceed to operation 611 and disable the cellular communication and short-range wireless communication or cut off power to the corresponding communication circuit. When the WiFi AP is found in operation 609, the processor 120 may proceed to operation 629 to transmit the emergency message through the WiFi AP.

According to one embodiment, the processor 120 may notify through the display that the survival mode is being executed in operation 613 and lower the screen brightness of the display in operation 615.

According to one embodiment, the processor 120 may terminate at least some of running applications except for essential apps in operation 617, and the processor 120 may have multiple cores to handle a large workload and increase a clock frequency to improve an operating speed. However, operating multiple cores and increasing the clock frequency may increase power consumption. In operation 619, some of the multiple cores of the processor, for example, only one may operate, and the operation of the remaining cores may be terminated, and the clock frequency of the processor may be minimized. This allows the processor 120 to reduce the power consumption of the electronic device 101.

According to one embodiment, in operation 621, the processor 120 may acquire current location information based on the GNSS signal. After the GNSS signal is acquired, the processor may cut off power to a GNSS front end (e.g., the GNSS front end 201 of FIG. 2) and/or a GNSS module (e.g., the GNSS receiver 221 of FIG. 2).

According to one embodiment, in operation 623, the processor 120 may start emergency satellite communication. For example, when the satellite communication starts, the processor 120 may generate a satellite communication signal, and amplify and transmit the satellite signal through a satellite communication front end (e.g., the satellite communication front end 202 of FIG. 2) and a satellite communication antenna (e.g., the satellite communication antenna 212 of FIG. 2).

According to one embodiment, the processor 120 may confirm whether the emergency satellite communication is available in operation 625, and if not possible, provide guidance on a location or time where the satellite communication is available in operation 627. For example, the processor 120 may confirm whether the satellite communication is available based on the strength of the GNSS signal. For example, when the strength of the GNSS signal is less than or equal to the designated level at which the satellite communication is available, the processor 120 may determine that the satellite communication is unavailable and confirm various pieces of environmental information. For example, the environmental information may include environmental information on the current location and time. For example, the environmental information may include various pieces of surrounding environmental information, including map information on the current location, status information of the electronic device 101 collected through the sensors, barometric pressure information collected through the memory 130 or sensors, and weather information.

According to one embodiment, the processor 120 may generate the guide information for performing the satellite communication based on the GNSS signal information, the status information of the electronic device 101, and the collected environmental information. For example, when it is determined that the antenna direction of the electronic device 101 is not toward the satellite based on the status information of the electronic device 101, the guide information on the satellite direction may be generated. For example, when the current location is inappropriate for performing satellite communication, for example, when the current location is at a lower altitude compared to the surroundings or when obstacles (e.g., forests or mountains) exist around the current location, guide information may be generated to move the electronic device 101 to other locations so as to perform the satellite communication. For example, when the current weather conditions, such as cloudy skies or rain, make the electronic device 101 inappropriate to perform the satellite communication, the guide information for a timing at which the satellite communication may be performed may be generated based on the weather information.

According to one embodiment, when it is confirmed that the emergency satellite communication is available in operation 625, the processor 120 may transmit the emergency message in operation 629. For example, the emergency message may be a rescue request message from a user and may include information such as the location, situation description, age, gender, and health condition of the user.

The processor 120 may maintain the survival mode after transmitting the emergency message and may release the survival mode upon receiving a completion message indicating that the processing of the emergency message by the satellite (e.g., satellite 301 and/or 302 in FIG. 3), a ground station (e.g., ground station 311 in FIG. 3), and/or an emergency center (e.g., emergency center 312 in FIG. 3) has been performed, rescue has started, or rescue has been completed.

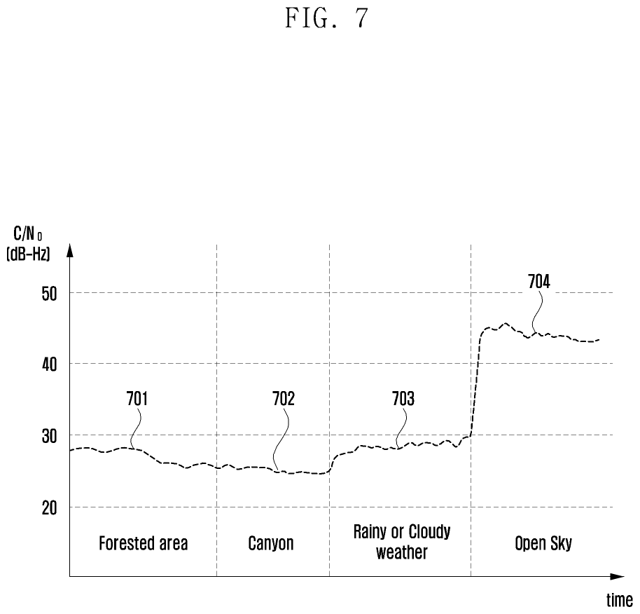

FIG. 7 is a diagram for describing the signal strength according to the surrounding environment of the electronic device (e.g., the electronic device 101 of FIG. 1 or 2) according to one embodiment.

Referring to the drawing, the strength of the GNSS signal (e.g., C/N0 level) varies depending on the surrounding environment. For example, in open skies, the C/N0 level may be greater than or equal to, for example, approximately 40 dB-Hz 704. In forested areas, the C/N0 level may be relatively lowered to, for example, approximately 20-30 dB-Hz 701 due to tree leaves and trunks. In canyons, the GNSS signal may be obscured by various obstacles, such as rocky terrain, resulting in a lower C/N0 level 702 compared to the open skies. Weather conditions, such as rain or cloudy skies, may also lower a C/N0 level 703 of the satellite signal compared to the open skies due to the impact of moisture.

According to one embodiment, the electronic device 101 may provide guidance on the location and/or time suitable for the satellite communication based on the C/N0 level of the GNSS.

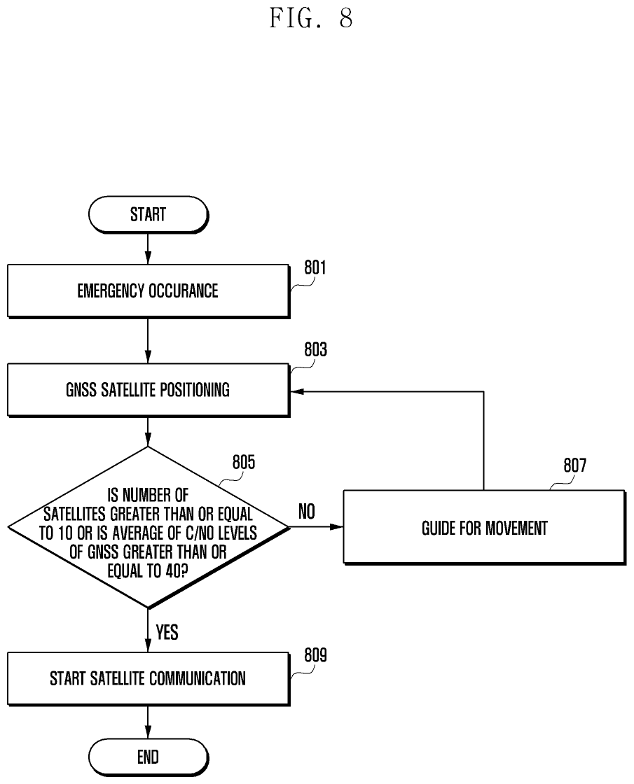

FIG. 8 is a flowchart for describing an example of a satellite communication service guidance operation performed by the electronic device (e.g., the electronic device 101 of FIG. 1 or 2) according to one embodiment.

In the following embodiments, each operation may be performed sequentially, but is not necessarily performed sequentially. Alternatively, the order of each operation may be changed, and at least two operations may also be performed in parallel. In some examples, one or more operations may be skipped or repeated one or more times.

According to one embodiment, in operation 801, the processor (e.g., the processor 120 of FIG. 1 or 2) of the electronic device 101 may determine that the emergency has occurred. For example, the processor 120 may determine that the emergency has occurred based on an external input. For example, the processor 120 may determine the occurrence of the emergency when the emergency communication function is activated in response to the designated situation, even in case the electronic device 101 being unable to access the wireless communication network.

According to one embodiment, the processor 120 may start GNSS satellite positioning in operation 803 according to the occurrence of the emergency. For example, by starting the GNSS satellite positioning, the processor 120 may receive the GNSS signal and confirm the strength of the GNSS signal (e.g., C/N0 level). For example, the processor 120 may confirm the number of GNSS satellites currently being received based on the GNSS satellite positioning.

According to one embodiment, the GNSS signal is transmitted from satellites that provide positioning services based on the satellite navigation systems such as GPS, GLONASS, Beidou, and Galileo. The strength of the GNSS signal as well as the number of GNSS satellites may reflect the satellite communication environment. For example, the number of GNSS satellites confirmed at a location where the satellite reception environment is good may be greater than or equal to the designated number (e.g., 10).

According to one embodiment, in operation 805, the processor 120 may determine to perform the satellite communication when the number of GNSS satellites from which the received signal is confirmed is greater than or equal to the designated number and/or when the strength (e.g., an average of CN0 levels) of the GNSS signal is greater than or equal to the designated level (e.g., a C/N0 level of 40 dB Hz), and may determine not to perform the satellite communication (not illustrated) when the number of GNSS satellites is less than the designated number and/or the strength of the GNSS signal is less than the designated level.

According to one embodiment, in operation 809, the processor 120 may start the emergency communication services to the electronic device 101 through satellite communication based on the performance determination of the satellite communication.

According to one embodiment, in operation 807, the processor 120 may provide guide information (e.g., movement guidance) for performing the satellite communication based on the non-performance determination of the satellite communication.

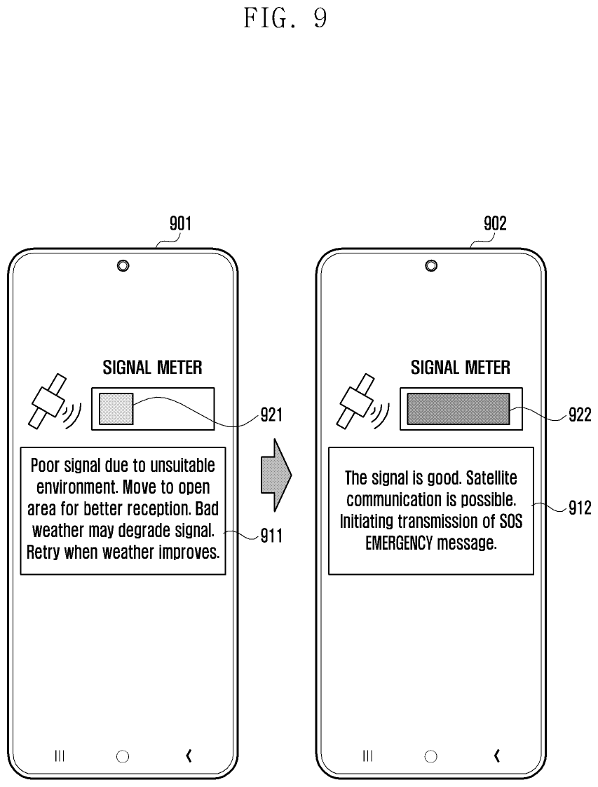

FIG. 9 is a diagram for describing the satellite communication guidance operation of the electronic device 101 according to one embodiment.

According to one embodiment, the processor (e.g., the processor 120 of FIG. 1 or 2) may receive the GNSS satellite signal to perform the satellite communications and provide satellite communication guidance on the current location and time based on the magnitude of the GNSS satellite signal, e.g., the C/N0 level.

According to one embodiment, the processor 120 may display a visual object 921 indicating the magnitude of the GNSS satellite signal on a screen 901. When the magnitude of the GNSS satellite signal is less than the designated level, the processor 120 may display, on the screen 901, guidance 911 including text and/or images providing information such as a description of the current signal environment, guidance on movement, guidance on weather, and guidance on retrying after a certain time delay. For example, when the C/N0 level of the GNSS signal is lowered at a level of, for example, approximately 20 to 30 dB-Hz, the processor 120 may guide the electronic device to move to an open sky region, or provide guidance such that the electronic device waits until the weather improves when it is rainy or cloudy, and then retries satellite communication.

According to one embodiment, when the magnitude of the GNSS satellite signal is greater than or equal to the designated level after the movement of location or a certain period of time, the processor 120 may display a visual object 922 indicating the magnitude of the GNSS satellite signal on a screen 902, and the processor may display, on a screen 902, guidance 912 including text and/or images providing guide information indicating the description of the current signal environment and the possibility of performing the emergency communication through the satellite communication. Visually displaying and providing the guidance 912 on the screen 902 according to one embodiment is merely an example, and embodiments are not limited thereto. The guide may be provided in various ways, including an auditory or tactile display, such as audio and/or haptic.

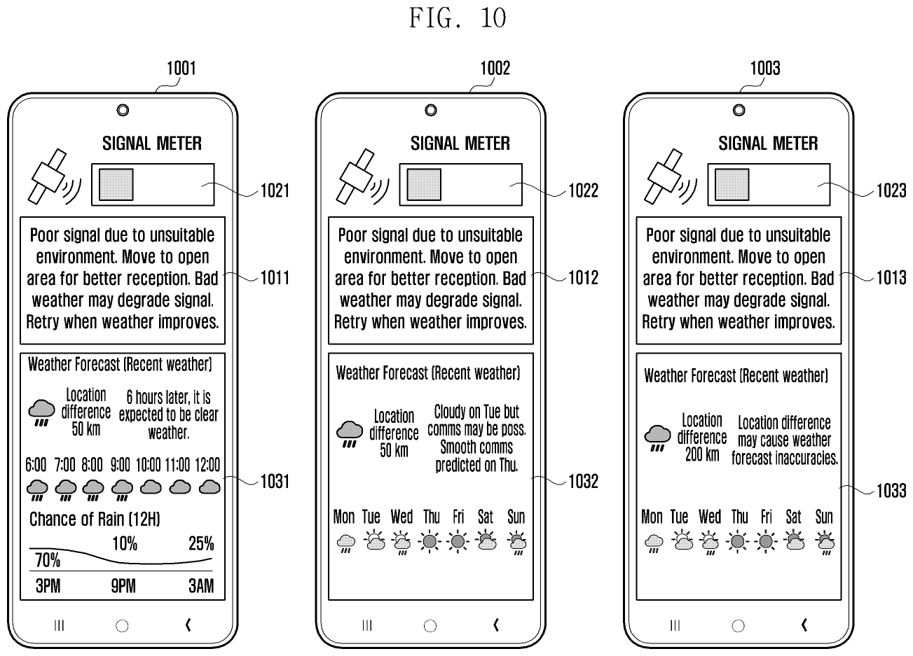

FIG. 10 is a diagram for describing the satellite communication service guidance operation of the electronic device according to one embodiment.

Generally, weather conditions (e.g., rain, cloud, snow, heavy rain) may act as a significant variable in performing the satellite communication.

According to one embodiment, the electronic device 101 may collect weather information when the wireless communication network operates upon the occurrence of the emergency, or the electronic device 101 may confirm, for example, weather information data previously collected and stored in the memory in a situation where it is difficult to collect the weather information through the wireless communication network, and provide the satellite communication guidance information in response to the confirmed weather information data.

According to one embodiment, the electronic device 101 may update weather information periodically (e.g., every 6 hours) or aperiodically in a region where the wireless network communication is available, and may collect, for example, a 24-hour weather forecast and/or a 7-day weather forecast.

According to one embodiment, the electronic device 101 may provide satellite communication guidance based on recently updated weather information even when the wireless network communication is unavailable.

Referring to FIG. 10, for example, when a 24-hour weather forecast is confirmed, the electronic device 101 may provide, on a screen 1001, not only satellite signal strength information 1021, but also guide information 1011 based on current weather (e.g., weather situation guidance, movement guidance, and/or guidance for retrying satellite communication after waiting for a predetermined time period according to a prediction of a time when satellite communication may be smooth) along with guidance 1031 on weather (e.g., weather conditions may improve after a certain period of time). For example, when a 7-day weather forecast is confirmed, the electronic device 101 may provide, on the screen 1002, not only satellite signal strength information 1022 but also guide information 1012 based on current weather along with guidance 1032 on weather forecast. For example, when the confirmed weather forecast is weather for a region significantly distant from the current location (e.g., more than the designated distance), the electronic device 101 may provide, on a screen 1003, not only satellite signal strength information 1023, but also guide information 1013 based on current weather for a region significantly distant from the current location (e.g., more than the designated distance) along with guidance 1033 on weather forecast (e.g., weather forecast may be inaccurate due to different locations).

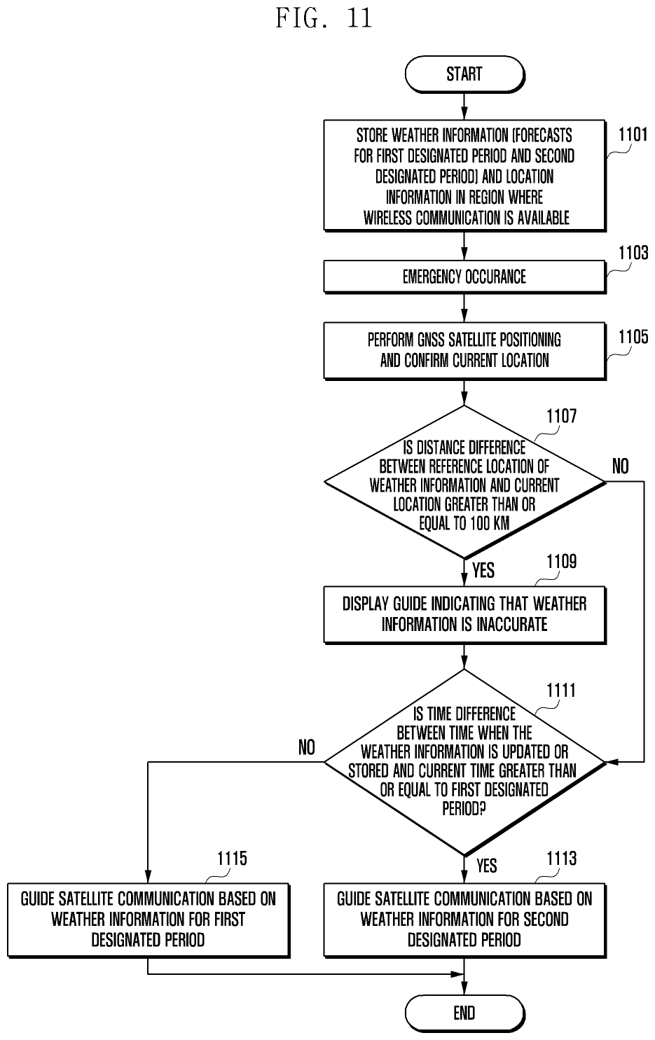

FIG. 11 is a flowchart for describing an example of a satellite communication service execution operation of the electronic device according to one embodiment.

In the following embodiments, each operation may be performed sequentially. Alternatively, the order of each operation may be changed, and at least two operations may also be performed in parallel. In some examples, one or more operations may be skipped or repeated one or more times.

According to one embodiment, in operation 1101, the processor (e.g., the processor 120 of FIG. 1 or 2) of the electronic device 101 may update weather information at regular intervals, for example, every 6 hours, when the electronic device 101 is located in the region where the wireless network communication is available, collect weather forecasts such as a 24-hour weather forecast and/or a 7-day weather forecast and store the collected weather forecasts in the memory, and may store location information at the time of collection in the memory.

According to one embodiment, in operation 1103, the processor 120 of the electronic device 101 may determine that the emergency has occurred. For example, the processor 120 of the electronic device 101 may determine that the emergency has occurred based on an external input. For example, the processor 120 may determine the occurrence of the emergency when the emergency communication function is activated in response to a designated situation, such as the electronic device 101 being unable to access the wireless communication network.

According to one embodiment, in operation 1105, the processor 120 of the electronic device 101 may perform GNSS satellite positioning and confirm a current location according to the occurrence of the emergency. For example, the processor 120 of the electronic device 101 may receive the GNSS signal through the GNSS positioning and measure the current location based on the GNSS signal. In addition, the electronic device 101 may confirm the strength (e.g., C/N0 level) of the GNSS signal.

According to one embodiment, the processor 120 of the electronic device 101 may, in operation 1107, confirm the stored weather information and confirm whether a distance difference between a reference location of the weather information and a current location is greater than or equal to the designated distance (e.g., 100 km), and when the distance difference is greater than or equal to the designated distance, display guide information indicating that the weather information may be inaccurate in operation 1109. Meanwhile, when the distance between the reference location of the weather information and the current location is not greater than or equal to the designated distance in operation 1107, the processor 120 may proceed to operation 1111.

According to one embodiment, the processor 120 of the electronic device 101 may confirm the time difference between the time when the weather information is updated or stored and a current time and confirm whether the time difference is a first designated period (e.g., 24 hours) or more in operation 1111, and when the time difference is greater than or equal to the first designated period, the processor may provide satellite communication guidance based on a weather forecast for a second designated period (e.g., 7 days) in operation 1113 and when the time difference is not greater than or equal to the first designated period, provide satellite communication guidance based on the weather forecast for the first designated period (e.g., 24 hours) in operation 1115.

Accordingly, the electronic device 101 may provide satellite communication guidance based on recently updated weather information even when the wireless network communication is unavailable. The satellite communication guidance may include, for example, various guidance information based on weather information, such as weather condition guidance, movement guidance, guidance to retry satellite communication after waiting for a certain time based on the prediction of the time when the satellite communication will be smooth, or guidance indicating that the confirmed weather forecast may be inaccurate due to the region significantly distant from the current location.

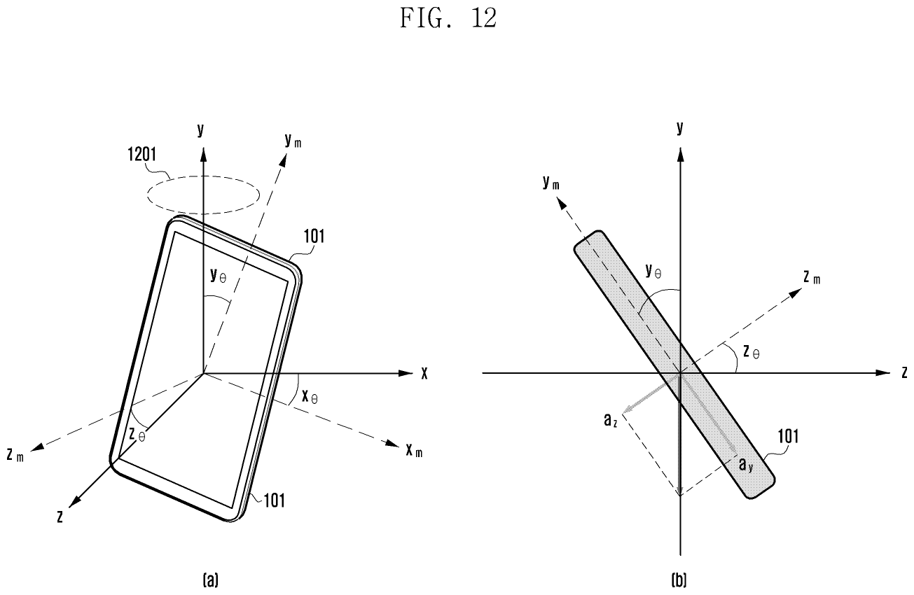

FIG. 12 is a diagram for describing an example of a satellite communication execution guidance operation performed by the electronic device (e.g., the electronic device 101 of FIG. 1 or 2) according to one embodiment.

According to one embodiment, the antenna (e.g., the antenna 212 of FIG. 2) for satellite communication in the electronic device 101 may be an antenna with directional characteristics. Accordingly, the smooth communication may be achieved by positioning the antenna 212 toward the satellite.

According to one embodiment, the processor (e.g., the processor 120 of FIG. 1 or 2) of the electronic device 101 may provide guidance on the posture, direction, and/or state of the electronic device 101 using an inertial sensor, such as an acceleration sensor.

According to one embodiment, the processor 120 may measure the posture, direction, and/or state of the electronic device 101 using a rectangular coordinate system (x, y, z coordinates) through the acceleration sensor.

Referring to FIG. 12, a reference coordinate system x, y, and z in the left graph is an absolute coordinate system with fixed axes. A central coordinate system xₘ, yₘ, and zₘ of the electronic device 101 may be a coordinate system whose axes change together with the change in the posture of the electronic device. When the posture of the electronic device changes, by comparing the two coordinate systems, the angles of misalignment of the axes x_{θ}, y_{θ}, and z_{θ}between the two coordinate systems may be measured using an acceleration sensor.

Referring to the right graph, the case where the x-axis remains unchanged but the y-and z-axes change may be represented. When gravitational acceleration acts downward (e.g., in the −y-axis direction), the acceleration sensor of the electronic device 101 may measure y-component a_{y} and z-component a_{z} of the gravitational acceleration. Accordingly, the angle of inclination of the electronic device 101 may be calculated (or determined) based on the magnitude of the measured acceleration.

According to one embodiment, the processor 120 may provide guidance based on the calculated value of the accelerometer such that the posture, direction, and/or state of the electronic device 101 falls within the designated range 1201 of y_{θ}, for example, a difference between the reference coordinate system and the central coordinate system of the electronic device 101. For example, a designated range 1201 may be a posture suitable for LOS with a satellite for satellite communication, and y_{θ} may be approximately 0 to 45°.

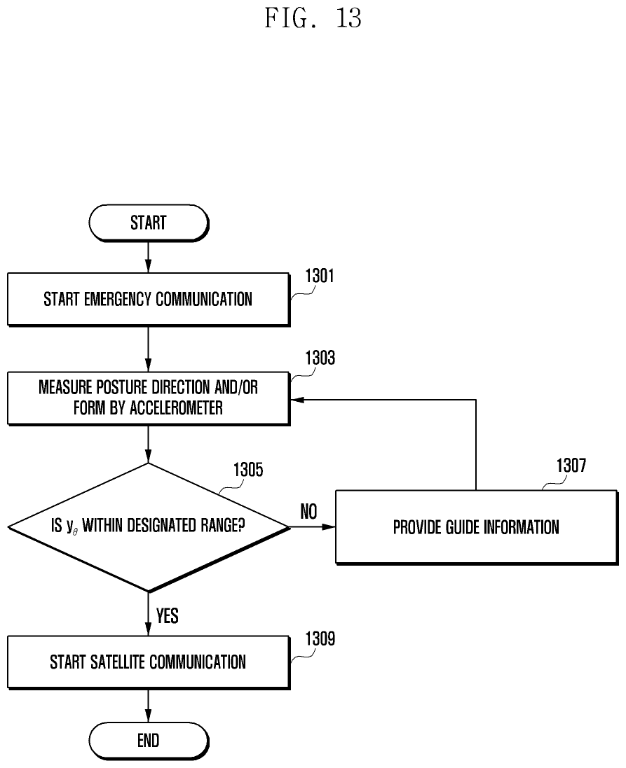

FIG. 13 is a flowchart for describing an example of the satellite communication service execution guidance operation of the electronic device 101 according to one embodiment.

In the following embodiments, each operation may be performed sequentially. Alternatively, the order of each operation may be changed, and at least two operations may also be performed in parallel. In some examples, one or more operations may be skipped or repeated one or more times.

According to one embodiment, the processor (e.g., the processor 120 of FIG. 1 or 2) of the electronic device 101 may measure the posture, direction, and/or form of the electronic device 101 through the acceleration sensor in operation 1303 when the emergency communication through the satellite communication starts in operation 1301.

According to one embodiment, the processor 120 may confirm whether the difference y_{θ} between the y-axis of the reference coordinate system of the electronic device and the yₘ-axis of the central coordinate system of the electronic device 101 is within the designated range 1201, for example, approximately 0 to 45°, in operation 1305, and when the difference y_{θ} is out of the range, may provide information (e.g., display indication, audio output) to guide the adjustment of the inclination or angle of the electronic device 101 within the designated range in operation 1307.

According to one embodiment, the processor 120 may start the satellite communication in operation 1309 when the difference yθ between the y-axis of the reference coordinate system of the electronic device and the yₘ-axis of the central coordinate system of the electronic device 101 is within the designated range (e.g., the range 1201 of FIG. 12), for example, approximately 0 to 45°, in operation 1305.

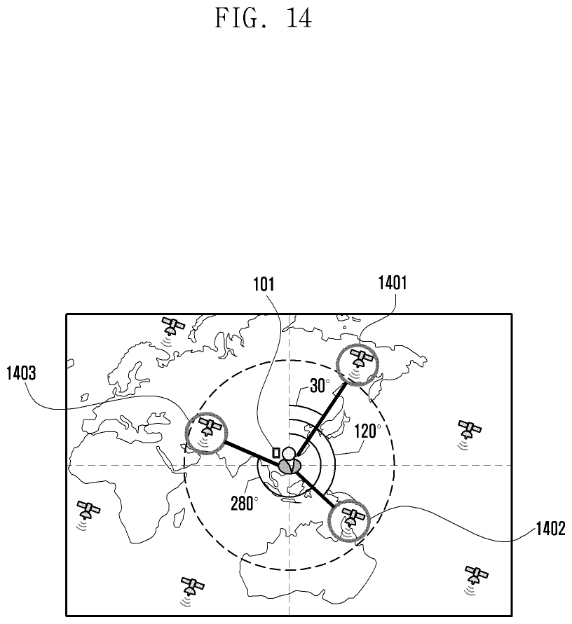

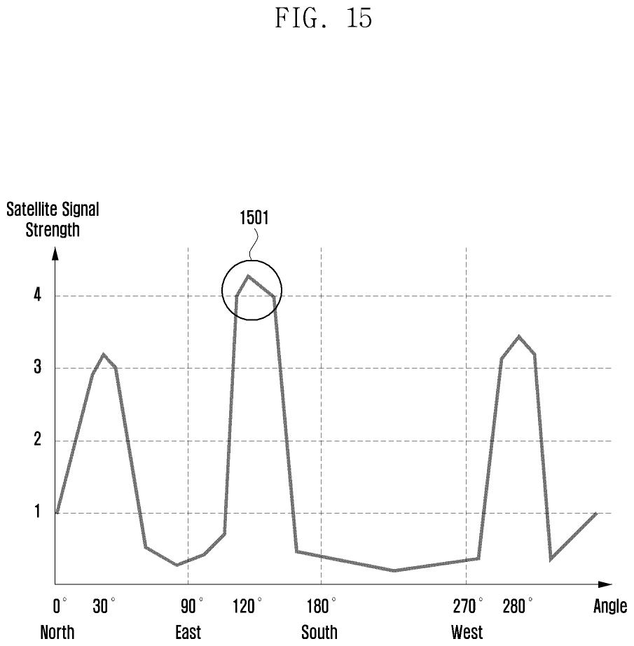

FIG. 14 is a diagram for describing the satellite communication service execution operation of the electronic device (e.g., the electronic device 101 of FIG. 1 or 2) according to one embodiment, and FIG. 15 is a diagram for describing signal strength according to directions of a plurality of satellite signals according to one embodiment.

According to one embodiment, the processor (e.g., the processor 120 of FIG. 1 or 2) of the electronic device 101 may guide the electronic device 101 to adjust its direction using a sensor, for example, a geomagnetic sensor.

According to one embodiment, the processor 120 may use a geomagnetic sensor to detect the direction of the communication satellite and guide the direction of the electronic device 101 based on the detected direction. The geomagnetic sensor may include a magnetometer or a compass sensor and may detect the Earth's magnetic field to determine the direction of the electronic device 101.

Referring to FIG. 14, the location of the communication satellite with respect to the electronic device 101 may be detected on a map, for example, in directions of approximately 30° 1401, approximately 120° 1402 , and approximately 280° 1403, respectively, relative to a user's center. The location of the communication satellite may frequently change over time, and the direction of the communication satellite may change accordingly. Therefore, the processor 120 needs to find the direction of the communication satellite at the time when the electronic device 101 performs the satellite communication.

According to one embodiment, the processor 120 may measure the signal strength received from the communication satellite in response to each of the directions of the electronic device 101 and guide the electronic device 101 to the direction where the strongest signal is received.

Referring to FIG. 15, the x-axis may represent the direction of the electronic device 101 measured by a geomagnetic sensor, and the y-axis may represent the satellite signal strength (e.g., signal-to-noise ratio (SNR)).

For example, depending on the direction of the electronic device 101, the satellite signal greater than or equal to the designated magnitude may be detected at angles or directions of approximately 30°, approximately 120°, and approximately 280°, respectively. It may be confirmed that satellite signal strength 1501 at an angle or direction of approximately 120° is the strongest among the detected satellite signal strengths. Accordingly, the processor 120 may provide guidance such that the electronic device 101 is positioned by rotating to a direction or an angle of approximately 120° of the satellite signal.

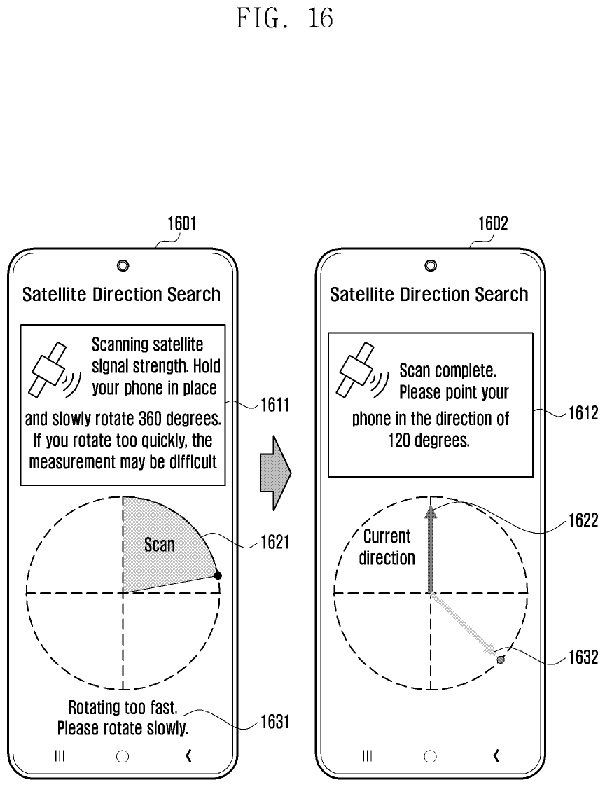

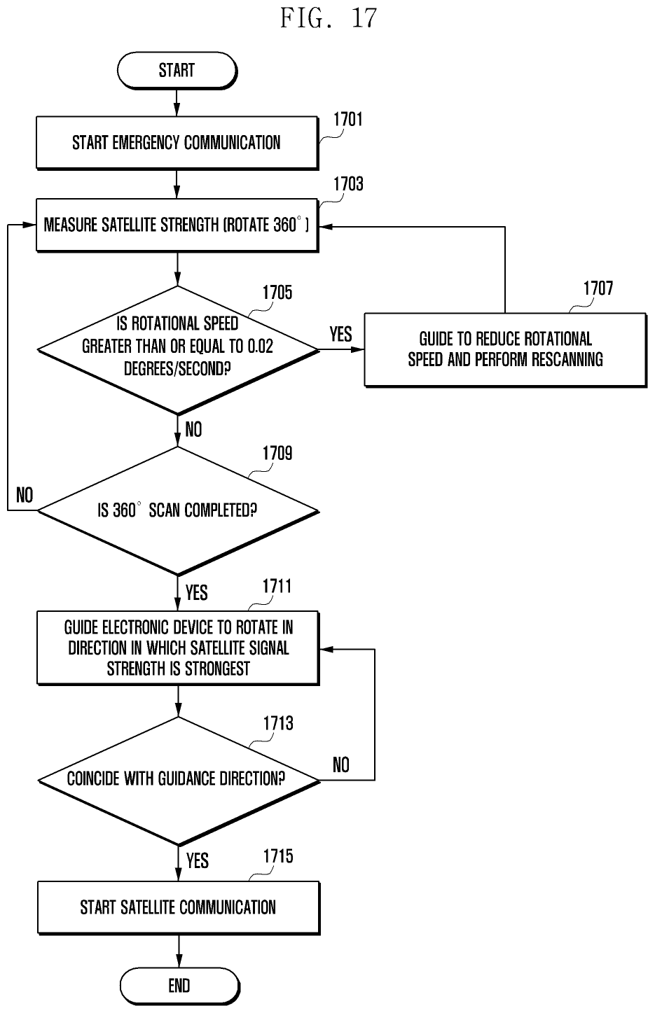

FIG. 16 is a diagram for describing an example of a satellite communication service execution guidance operation of the electronic device (e.g., the electronic device 101 of FIG. 1 or 2) according to one embodiment, and FIG. 17 is a flowchart for describing an example of a satellite communication service execution guidance operation of the electronic device according to one embodiment.

Referring to FIG. 16, the processor (e.g., the processor 120 of FIG. 1 or 2) of the electronic device 101 may provide guidance 1611, 1621, and/or 1631 including text and/or images through a display screen 1601 to scan the direction of the satellite while the electronic device 101 rotates at the designated speed. In addition, the processor 120 may provide guidance 1612, 1622, and/or 1632 including text and/or images through a display screen 1602 to rotate the electronic device 101 in the direction of the selected satellite based on the satellite direction scan. According to one embodiment, visually displaying and providing the guidance 1612, 1622, and/or 1632 through the display screen 1602 is an example, but embodiments are not limited thereto, and guidance may be provided through various schemes including an auditory or tactile display such as audio and/or haptic.

Referring to FIG. 17, when the emergency communication through the satellite communication starts in operation 1701, the processor (e.g., the processor 120 of FIG. 1 or 2) of the electronic device 101 may measure the satellite signal strength in each direction while measuring the direction during approximately 360° rotation of the electronic device 101 through, for example, a geomagnetic sensor in operation 1703.

According to one embodiment, the processor 120 may display guidance (e.g., the guidance 1611 of FIG. 16) including the text and/or images indicating that the electronic device 101 should be held and slowly rotated 360° to perform the scan for measuring the satellite signal strength.

According to one embodiment, the processor 120 may display guidance (e.g., the guidance 1621 of FIG. 16) including the text and/or images indicating that the scan is being performed, and may, for example, use the gyro sensor to indicate the rotational speed of the electronic device 101 by changing the guidance 1621 including the text and/or images (e.g., gradual expansion of a fan-shaped area indicating the angle at which the scan is completed).

According to one embodiment, when the rotational speed of the electronic device 101 is greater than or equal to the designated speed (e.g., approximately 0.02° per second) in operation 1705, the processor 120 may provide guidance to reduce the rotational speed of the electronic device 101 in operation 1707. For example, the processor 120 may display, on the screen (e.g., display screen 1601 of FIG. 16), guidance (e.g., guidance 1631 of FIG. 16) including text and/or an image indicating the reduction in the rotational speed.

According to one embodiment, when the rotational speed of the electronic device 101 is less than the designated speed, the processor 120 may confirm, in operation 1709, whether the scan has been completed, and, as approximately 360° scan is completed, may, in operation 1711, guide the electronic device 101 to rotate toward a direction or angle where the satellite signal strength is strongest. For example, the processor 120 may display, on a screen (e.g., the display screen 1602 of FIG. 16), guidance (e.g., the guidance 1612 of FIG. 16) including the text and/or images for guiding the completion of the scan and the adjustment of the direction of the electronic device 101. For example, the processor 120 may display, on the display screen 1602, the guidance including the text and/or images for guiding the adjustment of the direction of the electronic device 101. For example, an arrow image (e.g., the image 1622 of FIG. 16) indicating the current direction on the display screen 1602 may be displayed so that an angle between the arrow image and an arrow image (e.g., the image 1632 of FIG. 16) indicating the satellite direction narrows and overlaps as the electronic device 101 rotates.

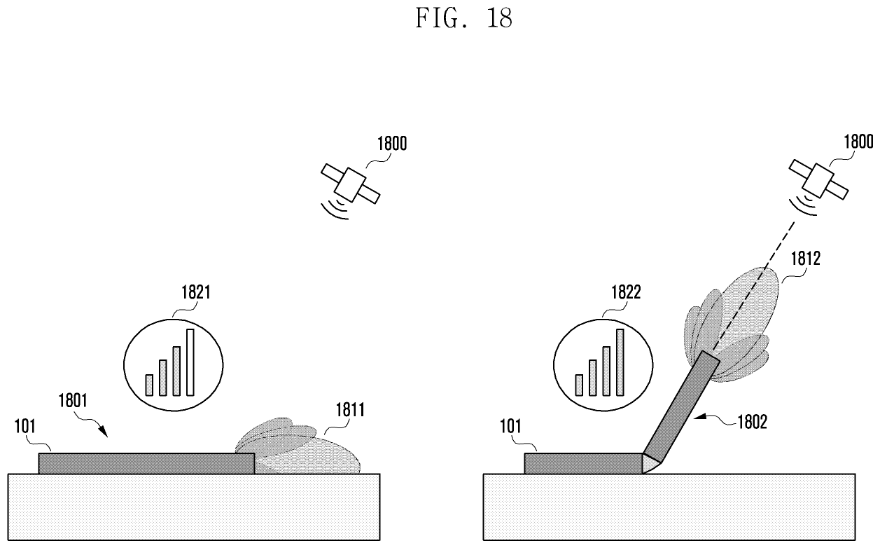

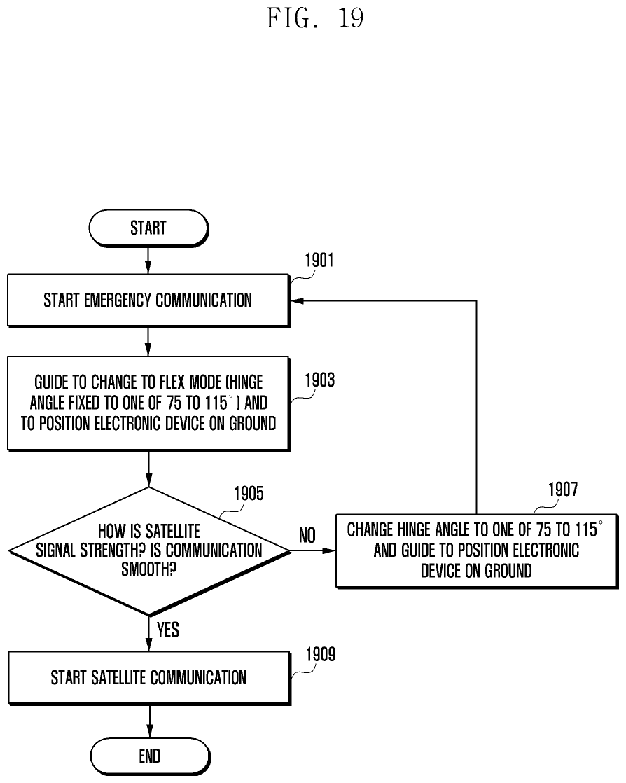

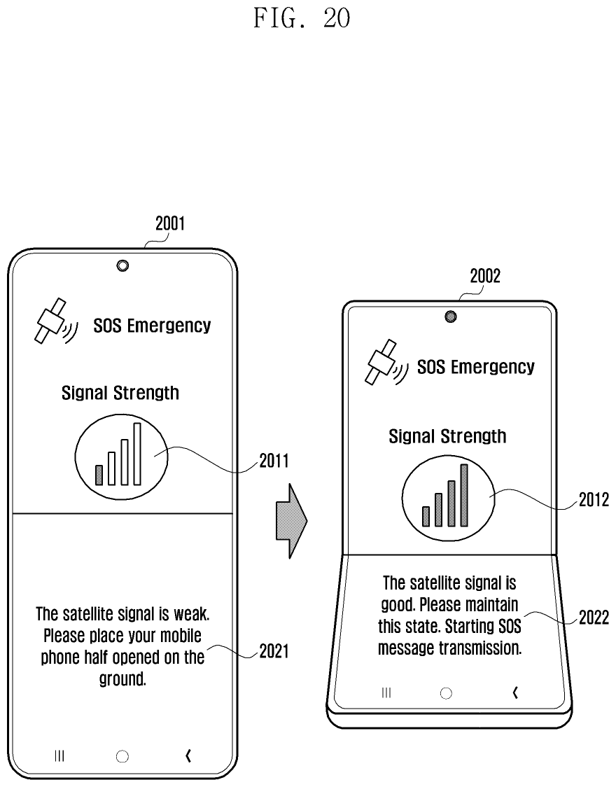

FIG. 18 is a diagram for describing the signal strength of the satellite signal according to a state of an electronic device (e.g., the electronic device 101 of FIG. 1 or 2) according to one embodiment, FIG. 19 is a flowchart for describing an example of a satellite communication service execution guidance operation of the electronic device 101 according to one embodiment, and FIG. 20 is a diagram for describing an example of a satellite communication service execution guidance operation of the electronic device 101 according to one embodiment.

Referring to FIG. 18 or 20, the electronic device 101 may be a foldable type device rather than a bar type device. In the case of the bar type device, for satellite communication, a user may need to hold the device so that the device faces the sky.

As illustrated, the foldable type electronic device 101 may be foldable, and may enable smoother satellite communication through, for example, a flex mode (e.g., a state in which a hinge angle is maintained at approximately 75 to 115°), which may be an intermediate state between folding and unfolding.

Referring to FIG. 18, when the electronic device 101 is laid flat on the floor in an unfolded state 1801, the directivity of the satellite communication antenna may be in a horizontal direction 1811 rather than toward a satellite 1800, so satellite communication signal strength 1821 may be relatively weak. When the electronic device 101 changes to the flex mode 1802, the directivity of the satellite communication antenna may be close to the satellite 1800 and thus in the satellite direction 1812, so the satellite communication signal strength 1822 may be relatively strong.

Referring to FIG. 19, when the emergency communication through the satellite communication starts in operation 1901, the processor 120 (e.g., the processor 120 of FIG. 1 or 2) of the electronic device 101 may, in operation 1903, confirm the state of the electronic device 101, change the state of the electronic device 101 to a flex mode (e.g., a state in which a hinge angle is maintained at approximately 75 to 115°), and guide the electronic device 101 to be positioned on the ground. Referring to FIG. 20, the processor 120 may display the satellite signal strength on a screen 2001 of the electronic device 101 as text 2021 and/or an image 2011. The processor 120 may provide guidance on the change in the satellite signal strength and/or the state of the electronic device 101 (e.g., change to the flex mode and position on the ground) through the text 2021 and/or image. Visually displaying and providing the guidance through the text and/or image according to one embodiment is merely an example, and embodiments are not limited thereto. The guidance may be provided in various ways, including an auditory or tactile display, such as audio and/or haptic.

According to one embodiment, the processor 120 may confirm the satellite signal strength received by the electronic device 101 in operation 1905. When the satellite signal strength is less than the designated level, in operation 1907, the processor 120 may change the state of the electronic device 101 to the flex mode (e.g., the state in which the hinge angle is maintained at approximately 75 to 115°) and guide the electronic device 101 to be positioned on the ground, thereby ensuring the smooth communication.

According to one embodiment, when the satellite signal strength received by the electronic device 101 is greater than or equal to the designated level in operation 1905, the processor 120 may start the satellite communication in operation 1909. Referring to FIG. 20, the processor 120 may display the satellite signal strength on the screen 2002 of the electronic device 101 as text 2022 and/or an image 2012. The processor 120 may provide guidance on the satellite signal strength and/or maintaining the state of the electronic device 101 (e.g., maintain the flex mode and/or maintain the position on the ground) through the text 2022 and/or image. Visually displaying and providing the guidance through the text and/or image according to one embodiment is merely an example, and embodiments are not limited thereto. The guidance may be provided in various ways, including an auditory or tactile display, such as audio and/or haptic.

According to various embodiments, an electronic device (e.g., the electronic device 101 of FIG. 1 or 2) includes a global navigation satellite system (GNSS) receiver (e.g., the GNSS receiver 221 of FIG. 2), a communication circuit (e.g., the communication module 190 of FIG. 1), a display (e.g., the display module 160 of FIG. 1 or 2), a memory (e.g., the memory 130 of FIG. 1), and a processor (e.g., the processor 120 of FIG. 1 or 2) connected to (e.g., physically connected, logically connected, operatively connected) the GNSS receiver, the communication circuit, the display, and the memory. The processor may be configured to control the operation of the electronic device in the designated operating mode based on the occurrence of the emergency, receive the GNSS signal through the GNSS receiver, determine whether to perform the satellite communication through the communication circuit based on the strength of the GNSS signal, provide the satellite communication performance service of the electronic device based on the performance determination of the satellite communication, and provide the guide information for performing the satellite communication through the display based on the non-performance determination of the of the satellite communication.

According to various embodiments, the processor may provide the guide information including at least one of the posture or direction of the electronic device for performing the satellite communication based on the strength of the GNSS signal.

According to various embodiments, the electronic device may further include a geomagnetic sensor, and the processor may confirm the posture of the electronic device through the geomagnetic sensor and provide the guide information for guiding the change in the posture of the electronic device.

According to various embodiments, the electronic device may further include a gyro sensor, and the processor may confirm the direction of the electronic device through the gyro sensor and provide the guide information for guiding the change in the direction of the electronic device.

According to various embodiments, the processor may compare the direction of the electronic device confirmed through the gyro sensor with the satellite communication signal strength confirmed through the communication circuit to provide the guide information for guiding the change in the direction of the electronic device.

According to various embodiments, the processor may provide the guide information for rotating the electronic device at the designated speed in order to compare the satellite communication signal strength with the direction of the electronic device.

According to various embodiments, the electronic device may be implemented as a foldable type in which the display may be folded, and the processor may provide the guide information for folding the display within the designated angle range and positioning the electronic device on the ground.

According to various embodiments, the processor may acquire environmental information including at least one of location information, obstacle information, altitude information, or weather information, and generate the guide information based on the environmental information.

According to various embodiments, the processor may acquire the weather information from the memory and compare the weather information with current location and time information acquired through the GNSS signal to generate the guide information.

According to various embodiments, the processor may perform at least one of the following operations: blocking the wireless network communication function through the communication circuit of the electronic device, adjusting the display screen brightness, terminating an app being executed by the processor, blocking one or more core operations, and changing the clock frequency, depending on the designated operating mode.

The embodiments disclosed in the present disclosure are merely examples presented to facilitate easy description and understanding of the technical contents, and are not intended to limit the scope of the technology disclosed in the present disclosure. Therefore, the scope of the technology disclosed in the present disclosure should be interpreted to include all modifications or variations derived based on the technical concepts of the various embodiments disclosed in the present disclosure, in addition to the embodiments disclosed herein.

Various embodiments of the present disclosure and terms used herein are not intended to limit the technical features described in the present disclosure to specific embodiments, and should be understood to include various changes, equivalents, or substitutes of the embodiments.

Throughout the accompanying drawings, similar or related components will be denoted by similar reference numerals. A singular form of a noun corresponding to an item may include one or more of the item, unless the relevant context clearly dictates otherwise.

In the present disclosure, Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items”indicates multiple items).

Terms such as “first,” “second,” “1^{st},” or “2^{nd}” may simply be used to distinguish a component from another component, and do not limit the components in other respects (e.g., importance or order). When one (e.g., first) component is “coupled,” or “connected,” to another (e.g., second) component with or without the terms “functionally” or “communicatively,” it means that the one component may be connected to another component directly (e.g., in a wired manner), in a wireless manner, or through a third component.

Terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into specification as if it were individually recited herein.

Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term. Number of items in a plurality is at least two, but can be more when so indicated either explicitly or by context.

Further, unless stated otherwise or otherwise clear from context, phrase “based on” means “based at least in part on” and not “based solely on.” When examples describe at least one processor performing one or more operations described herein, this indicates that the at least one processor is configured to perform the one or more operations. Additionally or alternatively, the at least one processor (e.g., individually or collectively) may perform one or more instructions stored in memory to perform the one or more operations or cause the apparatus or device to perform the one or more operations.

The embodiments disclosed in the present disclosure disclosed in the present specification and drawings present merely specific examples to easily describe the technical contents according to the embodiments of the present disclosure and to help understand the embodiments of the present disclosure, and are not intended to limit the scope of the embodiments of the present disclosure. Therefore, the scope of an embodiment disclosed in the present disclosure should be interpreted to include all changes or modified forms derived based on the technical teachings of an embodiment disclosed in the present disclosure, in addition to the embodiments disclosed herein.

What is claimed is:

1. An electronic device, comprising:
a global navigation satellite system (GNSS) receiver;
a communication circuit;
a display;
memory; and
at least one processor connected to the GNSS receiver, the communication circuit, the display, and the memory,
wherein the at least one processor is configured to:
control an operation of the electronic device in a designated operating mode based on an occurrence of an emergency, and receive a GNSS signal through the GNSS receiver;
determine, based on a strength of the GNSS signal, whether to perform satellite communication through the communication circuit; and
provide, through the display, guide information for performing the satellite communication based on non-performance determination of the satellite communication.

2. The electronic device of claim 1, wherein the at least one processor is further configured to provide, based on the strength of the GNSS signal, the guide information comprising at least one of a posture or a direction of the electronic device for performing the satellite communication.

3. The electronic device of claim 2, further comprising:
a geomagnetic sensor,
wherein the at least one processor is further configured to:
confirm the posture of the electronic device through the geomagnetic sensor; and
provide the guide information for guiding a change in the posture of the electronic device.

4. The electronic device of claim 2, further comprising:
a gyro sensor,
wherein the at least one processor is further configured to:
confirm the direction of the electronic device through the gyro sensor; and
provide the guide information for guiding a change in the direction of the electronic device.

5. The electronic device of claim 4, wherein the at least one processor is further configured to:
compare the direction of the electronic device confirmed through the gyro sensor with satellite communication signal strength confirmed through the communication circuit; and
based on the comparison, provide the guide information for guiding the change in the direction of the electronic device.

6. The electronic device of claim 4, wherein the at least one processor is configured to provide the guide information for rotating the electronic device at a designated speed in order to compare the satellite communication signal strength with the direction of the electronic device.

7. The electronic device of claim 1, wherein the electronic device is foldable device with the display being foldable, and
the at least one processor is configured to provide the guide information for folding the display within a designated angle range and for positioning the electronic device on a ground.

8. The electronic device of claim 1, wherein the at least one processor is configured to:
acquire environmental information comprising at least one of location information, obstacle information, altitude information, or weather information; and
generate the guide information based on the environmental information.

9. The electronic device of claim 8, wherein the at least one processor is configured to:
acquire the weather information from the memory;
compare the weather information with a current location and time information acquired through the GNSS signal; and
generate the guide information based on the comparison.

10. The electronic device of claim 1, wherein the processor is configured to:
block, depending on the designated operating mode, a wireless network communication function through the communication circuit;
adjust a brightness of the display;
terminate an application being executed by the at least one processor;
block one or more core operations; and
change a clock frequency.

11. A method of an electronic device, comprising:
controlling an operation of the electronic device in a designated operating mode based on an occurrence of an emergency;
receiving a global navigation satellite system (GNSS) signal through a GNSS receiver of the electronic device;
determining, based on a strength of the GNSS signal, whether to perform satellite communication through a communication circuit of the electronic device; and
providing, through a display of the electronic device, guide information for performing the satellite communication based on non-performance determination of the satellite communication.

12. The method of claim 11, wherein, the providing of the guide information comprises providing the guide information including at least one of a posture or a direction of the electronic device for performing the satellite communication based on the strength of the GNSS signal.

13. The method of claim 12, wherein, the providing of the guide information comprises:
providing the posture of the electronic device is confirmed through a geomagnetic sensor of the electronic device, the guide information for guiding a change in the posture of the electronic device; and
providing the guide information for confirming the direction of the electronic device through a gyro sensor of the electronic device and guiding a change in the direction of the electronic device.

14. The method of claim 13, wherein, the providing of the guide information comprises comparing the direction of the electronic device confirmed through the gyro sensor with satellite communication signal strength confirmed through the communication circuit to provide the guide information for guiding the change in the direction of the electronic device.

15. The method of claim 13, wherein the providing of the guide information comprises providing the guide information for rotating the electronic device at a designated speed in order to compare the satellite communication signal strength with the direction of the electronic device.

16. The method of claim 11, wherein the electronic device is foldable device with the display being foldable, and
the providing of the guide information comprises providing the guide information for folding the display within a designated angle range and for positioning the electronic device on a ground.

17. The method of claim 11, further comprising:
acquiring environmental information comprising at least one of location information, obstacle information, altitude information, or weather information; and
generating the guide information based on the environmental information.

18. The method of claim 17, further comprising
acquiring the weather information from a memory of the electronic device;
comparing the weather information with a current location and time information acquired through the GNSS signal; and
generating the guide information based on the comparison.

19. The method of claim 11, wherein the controlling an operation of the electronic device in the designated operating mode comprises:
blocking a wireless network communication function;
adjusting a brightness of the display;
terminating an application being executed;
blocking one or more core operations of a processor; and
changing a clock frequency.

20. A non-transitory computer-readable storage medium having stored thereon instructions that, when executed by a processor, cause the processor to:
control an operation of an electronic device in a designated operating mode based on an occurrence of an emergency, and receiving a GNSS signal through a global navigation satellite system (GNSS) receiver of an electronic device;
determine, based on a strength of the GNSS signal, whether to perform satellite communication through a communication circuit of the electronic device; and
provide, through the display of the electronic device, guide information for performing the satellite communication based on non-performance determination of the satellite communication.
